(19) United States
(12) Patent Application Publication
(10) Pub. No.: US 2023/0360062 A1
(43) Pub. Date: Nov. 9, 2023

(54) CREDENTIAL MISUSE DETECTION VIA ENTROPIC ANALYSIS OF STREAMING BEHAVIOR VARIABILITY

(71) Applicant: Charter Communications Operating, LLC, St. Louis, MO (US)

(72) Inventors: Christoph Scheidiger, Denver, CO (US); Brock Bose, Denver, CO (US); Yizhe Xu, Seattle, WA (US)

(73) Assignee: Charter Communications Operating, LLC, St. Louis, MO (US)

(21) Appl. No.: 18/354,360

(22) Filed: Jul. 18, 2023

Related U.S. Application Data
(63) Continuation of application No. 16/787,263, filed on Feb. 11, 2020.

(51) Int. Cl. G06Q 30/018; H04N 21/258; G06Q 50/26; G06N 7/01

(52) U.S. Cl. CPC G06Q 30/0185; H04N 21/25866; G06Q 50/265; G06N 7/01

(57) ABSTRACT

A computer-implemented method for determining a credential sharing of a video streaming service account based on entropy of streaming data is described. The method includes determining an account entropy based on a viewing probability distribution for a total amount of content streamed for a defined account within a defined analysis period, grouping the total amount of content streamed into groups based on an account-stream characteristic that has probabilistic utility in determining the credential sharing, determining a group entropy for each of the groups, determining a watch-time variability based on the account entropy and each group entropy, and determining the credential sharing for the defined account based on the watch-time variability. The watch-time variability measures an increase in disorder when two or more groups of the groups are unrelated with respect to the account-stream characteristic.

### CROSS REFERENCE TO RELATED APPLICATION

This application is a continuation of U.S. patent application Ser. No. 16/787,263, filed on Feb. 11, 2020, of which is incorporated herein by reference.

### TECHNICAL FIELD

This disclosure relates to the credential misuse detection, such as a detection of an unauthorized credential usage. More specifically, this disclosure relates to quantifying account viewing behavior through entropic analysis and utilizing this streaming behavior variability in determining the detection of the unauthorized credential usage.

### BACKGROUND

The ability to stream content on a multiplicity of devices and at different locations engenders potentially fraudulent use of an account or credential sharing. Detection of credential sharing, however, is not straightforward. For example, while a large number of devices or streaming locations may be suspicious for an account, the usage scenario may be due to a highly mobile customer, a large number of family members, and similar factors which collectively provide a legal basis for use of the account beyond just the home location. A good fraud or credential sharing indicator should not penalize legal use cases due to a high number of devices, streaming locations, or both but be sensitive enough to determine credential sharing. To be a good indicator of credential sharing propensity, the indicator should have a high probability of remaining small when applied to accounts in which no credential sharing is occurring, and a high probability of being large as the incidence of credential sharing increases.

### SUMMARY

Disclosed herein are methods and systems for determining watch-time variability and using the watch-time variability as a credential sharing indicator.

In embodiments, a method for determining watch-time variability includes obtaining account and streaming data for streams viewed on an account using an account password, generating a viewing probability distribution for the account, generating an account entropy based on the viewing probability distribution, grouping the streams into two or more groups, where the grouping uses an account-stream characteristic which has a probabilistic utility to indicate account password sharing. generating a group entropy for each of the two or more groups, determining a watch-time variability based on the account entropy and each group entropy, where the watch-time variability measures the increase in disorder when the two or more groups are unrelated with respect to the account-stream characteristic, and providing an indication of account password sharing to limit activity on the account.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a diagram of an example streaming architecture in accordance with some embodiments of this disclosure.

FIG. 2 is a block diagram of an example of a device in accordance with embodiments of this disclosure.

FIGS. 3 and 4 are diagrams of content usage in accordance with embodiments of this disclosure.

FIG. 5 is a graph of content consumption distribution in accordance with embodiments of this disclosure.

FIG. 6 is a diagram of cluster distribution in accordance with embodiments of this disclosure.

FIG. 7 is a flowchart of an example method for determining watch-time variability in accordance with embodiments of this disclosure.

FIG. 8 is a flowchart of an example method for determining credential sharing using watch-time variability in accordance with embodiments of this disclosure.

### DETAILED DESCRIPTION

Reference will now be made in greater detail to embodiments of the invention, examples of which are illustrated in the accompanying drawings. Wherever possible, the same reference numerals will be used throughout the drawings and the description to refer to the same or like parts.

As used herein, the terminology “computer” or “computing device” includes any unit, or combination of units, capable of performing any method, or any portion or portions thereof, disclosed herein.

As used herein, the terminology “processor” indicates one or more processors, such as one or more special purpose processors, one or more digital signal processors, one or more microprocessors, one or more controllers, one or more microcontrollers, one or more application processors, one or more central processing units (CPU)s, one or more graphics processing units (GPU)s, one or more digital signal processors (DSP)s, one or more application specific integrated circuits (ASIC)s, one or more application specific standard products, one or more field programmable gate arrays, any other type or combination of integrated circuits, one or more state machines, or any combination thereof.

As used herein, the terminology “memory” indicates any computer-usable or computer-readable medium or device that can tangibly contain, store, communicate, or transport any signal or information that may be used by or in connection with any processor. For example, a memory may be one or more read-only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the term “application” refers generally to a unit of executable software that implements or performs one or more functions, tasks or activities. For example, applications may perform one or more functions including, but not limited to, telephony, web browsers, e-commerce transactions, media players, travel scheduling and management, smart home management, entertainment, and the like. The unit of executable software generally runs in a predetermined environment and/or a processor.

As used herein, the terminology “determine” and “identify,” or any variations thereof includes selecting, ascertaining, computing, looking up, receiving, determining, establishing, obtaining, or otherwise identifying or determining in any manner whatsoever using one or more of the devices and methods are shown and described herein.

As used herein, the terminology “example,” “the embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is unless specified otherwise, or clear from context, “X includes A or B” is intended to indicate any of the natural inclusive permutations. That is if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

Further, the figures and descriptions provided herein may be simplified to illustrate aspects of the described embodiments that are relevant for a clear understanding of the herein disclosed processes, machines, manufactures, and/or compositions of matter, while eliminating for the purpose of clarity other aspects that may be found in typical similar devices, systems, compositions and methods. Those of ordinary skill may thus recognize that other elements and/or steps may be desirable or necessary to implement the devices, systems, compositions and methods described herein. However, because such elements and steps are well known in the art, and because they do not facilitate a better understanding of the disclosed embodiments, a discussion of such elements and steps may not be provided herein. However, the present disclosure is deemed to inherently include all such elements, variations, and modifications to the described aspects that would be known to those of ordinary skill in the pertinent art in light of the discussion herein.

Described herein are methods, devices and systems for determining watch-time variability and using watch-time variability for detection of credential sharing. Watch-time variability is a numeric indicator which measures the likelihood that an account's credentials have been shared outside an immediate household. The watch-time variability more directly measures the lack of a coupling of watching behavior between the two or more groups. The lack of such coupling within an account is seen as suspicious since a typical household is expected to share resources (devices), activities, and interests which are reflected in their viewing behavior. The indicator measures the increase in disorder in viewing habits associated with an account caused by the superposition of the viewing habits of two or more independent households that are unconstrained by shared resources or close social contact. That is, the viewing habits of the members of a household tend to be synchronized owing to social contact. This promotes consuming the same content and using shared resources, which tends to constrain the number of different pieces of content that can be consumed during prime viewing hours. That is, the shared resources constrain the number of pieces of content that can be consumed in a strict or hard way and the shared social contact constrains the variability of the content in a loose or soft way.

In an implementation, the watch-time variability measures the reduction in disorder of an account's viewing habits under a segmentation of streams by behavioral patterns compared against the disorder in the viewing habits of the account as a taken as a whole. The watch-time variability is a numeric expression of the information gain provided by the grouping of the streams by the aforementioned behavioral patterns. In an implementation, the watch-time variability measures entropy differentiation resulting from stream segmentation.

In an implementation, the watch-time variability utilizes content viewing patterns and the related content consumption distribution to differentiate between or identify the existence of multiple households with respect to a single account. For example, a content viewing pattern for an individual is regular and predictable in time when they occur, the location at which they occur, and the device on which the content is consumed. The content viewing pattern may be expressed as a distribution of content consumption over a periodic time interval, such as a day, week, or year. The associated content consumption distribution should indicate, with respect to the individual, a household unit which is coupled by proximity and use of shared resources.

In an illustrative example, suppose a household of four people has three televisions tied to an account. If a member of the household prefers to watch a piece of content after school, they may choose to watch it on any of the televisions. When this consumption pattern is analyzed at the device level, it may appear very erratic since it will appear randomly on each device one third of the time, but when aggregated over all the devices associated with the household it becomes regular since it will appear in the household every day at the same time. Thus, one expects that identification of the streams originating from the devices associated with the household unit should result in minimum entropy with regards to the content consumption.

Now, assume the addition of another household which is unconstrained by proximity and shared resources. The addition of the new household should introduce additional entropy into the account's consumption patterns. That is, randomness in the content viewing patterns and related content consumption distribution will have increased and/or changed the entropy level. In this case, since the households are effectively independent in their viewing behavior, splitting the viewership based on households should allow recovery of a new minimum entropy state. Watch-time variability variability provides a mechanism to identify if there is a lack of coordination in viewing patterns that results from things like shared resources and social interaction. The existence of an independent set of resources would lack this coordination and would thus indicate the existence of a separate household. The watch-time variability method or metric is the information gain of viewing habits based on segmentation of viewing resources.

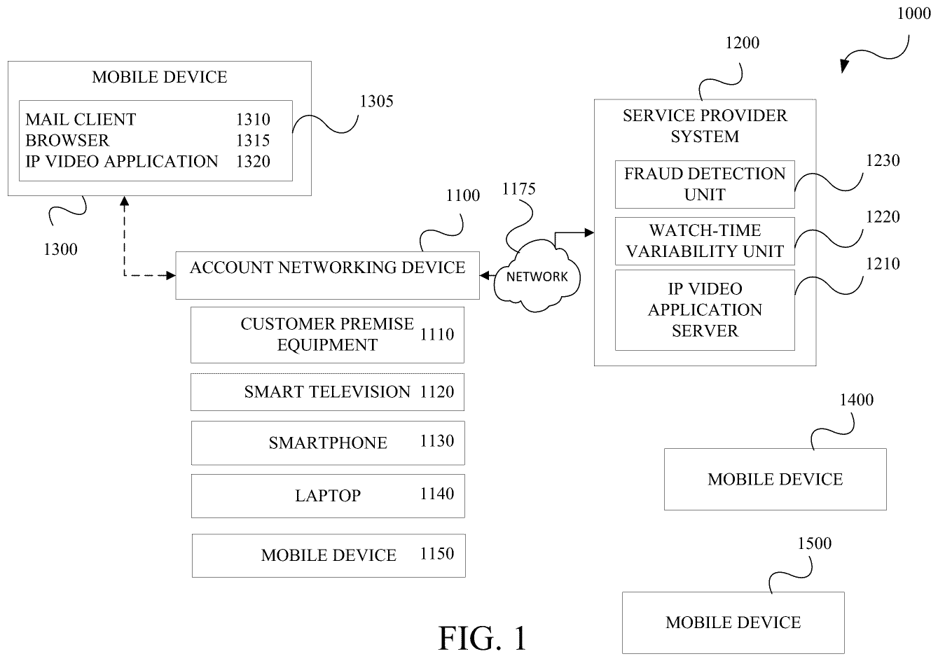

FIG. 1 is a diagram of an example architecture 1000 in accordance with some embodiments of this disclosure. In an implementation, the architecture 1000 may include an account networking device 1100 which is associated with, but not limited to, a home, an office, a business, and the like. An Internet Protocol (IP) address is associated with the account networking device 1100 to enable the streaming of content. The account networking device 1100 may be connected to or in communication with (collectively “connected to”) a service provider system 1200 via a network 1175. A mobile device 1300 was connected to the account networking device 1100 at some point in time and streamed content by accessing the IP address of the account networking device 1100. In an implementation, the mobile device 1300 may connect to the account networking device 1100 on an intermittent basis. Mobile devices 1400 and 1500 have never connected to the account networking device 1100 and/or have not streamed content via the IP address of the account networking device 1100. The architecture 1000 is illustrative and may include additional, fewer or different devices, entities and the like which may be similarly or differently architected without departing from the scope of the specification and claims herein. Moreover, the illustrated devices may perform other functions without departing from the scope of the specification and claims herein.

The account networking device 1100 may be a router, gateway device, set-top box, modem, and like device which provides connectivity including Internet connectivity, wired connectivity, wireless connectivity, and combinations thereof. The account networking device 1100 may be associated with an account and a password, credential, or like access verification identifier to access or watch content via the account. The account networking device 1100 may have with a number of streaming devices associated with it, including for example, customer premises equipment 1110, smart television(s) 1120, smartphone(s) 1130, laptop(s) 1140, mobile device(s) 1150, and other streaming devices such as set-top boxes, personal computers (PCs), cellular telephones, Internet Protocol (IP) devices, computers, desktop computers, handheld computers, PDAs, personal media devices, notebooks, notepads, phablets and the like. The account networking device 1100 may be associated with an Internet Protocol (IP) address via which content is streamed to the streaming devices such as the customer premises equipment 1110, the smart television(s) 1120, the smartphone(s) 1130, the laptop(s) 1140, and the mobile device(s) 1150. Each of the streaming devices may include applications such as, but not limited to, a mail application, a web browser application, an IP telephony application, an IP video application, and the like.

Each of the mobile devices 1150, 1300, 1400, and 1500 may be, end user devices, cellular telephones, Internet Protocol (IP) devices, mobile computers, laptops, handheld computers, PDAs, personal media devices, smartphones, notebooks, notepads, phablets and the like. For example, in an implementation, each of the mobile devices 1150, 1300, 1400, and 1500 may include applications such as, but not limited to, a mail application, a web browser application, an IP telephony application, an IP video application, and the like. For example, mobile device 1300 may include applications 1305 such as, but not limited to, a mail application 1310, a web browser application 1320, an IP video application 1330, and the like.

The service provider system 1200 may provide connectivity and content to the streaming devices via the account networking device 1100, mobile device 1300, mobile device 1400, and mobile device 1500. The service provider system 1200 may include, but is not limited to, an IP video application server 1210, a watch-time variability unit 1220, and a fraud detection unit 1230. In an implementation, the IP video application server 1210, the watch-time variability unit 1220, and the fraud detection unit 1230 may be an integrated server or element. In an implementation, the watch-time variability unit 1220 and the fraud detection unit 1230 may be an integrated server or element. The service provider system 1200 is illustrative and may include additional, fewer or different devices, entities and the like which may be similarly or differently architected without departing from the scope of the specification and claims herein.

The IP video application server 1210 may communicate with the IP video applications on the streaming devices and the mobile devices, such as the IP video application 1330 of mobile device 1300. In an implementation, the communication may be via an IP network. The communication may include content and control data. In an implementation, the control data may include, but is not limited to, account number, streaming device identification numbers, timestamps indicating when streaming started, length of times content(s) was watched, IP address(es) associated while content(s) was streaming, whether the streaming device(s) was at the account location and network while content was streaming, and like information.

The watch-time variability unit 1220 may use the content and control data obtained by IP video application server 1210 from the IP video applications running on the streaming devices to determine a watch-time variable for an account. In an implementation, an account viewing probability distribution is determined for the total content consumption over a defined period of time, where the defined period of time is divided into defined time bins. An account entropy is determined based on the account viewing probability distribution. Stream segmentation is then applied to generate multiple stream groupings and determine the effect on the account entropy, where stream segmentation divides the content using different content attributes. In an implementation, stream segmentation is based on the IP addresses and streaming devices information. A stream group entropy is determined for each stream group. The watch-time variability is then determined by subtracting each weighted stream group entropy from the account entropy. A smaller value for watch-time variability may indicate no credential sharing and a larger value for watch-time variability may indicate credential sharing.

The fraud detection unit 1230 may determine fraud based on the watch-time variability and other fraud detection factors. That is, the fraud detection unit 1230 may determine whether credentials with respect to an account are being shared with non-household members or non-account household members. For example, other fraud detection factors may include out-of-home devices, non-home account network usage, non-home account location usage, out-of-home streaming volume, total concurrent streams, distant events relative to home account location, repeat device types, weighted concurrent streams, and the like. In implementations, each fraud detection factor may have a weight based on reliability, accuracy, correctness, and the like.

The network 1175 may be, but is not limited to, the Internet, an intranet, a local area network (LAN), a wide area network (WAN), a public network, a private network, a cellular network, a WiFi-based network, a telephone network, a landline network, public switched telephone network (PSTN), a wireless network, a wired network, a private branch exchange (PBX), an Integrated Services Digital Network (ISDN), a IP Multimedia Services (IMS) network, a Voice over Internet Protocol (VoIP) network, and like including any combinations thereof.

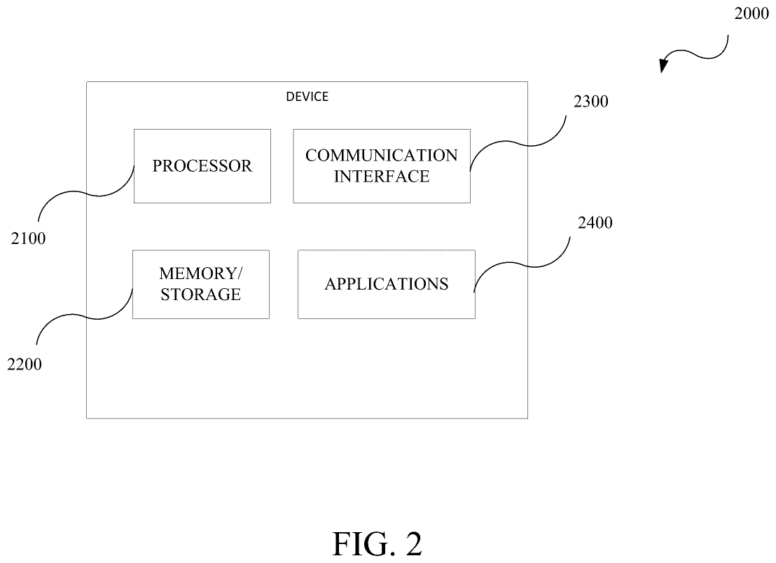

FIG. 2 is a block diagram of an example of a device 2000 in accordance with embodiments of this disclosure. The device 2000 may include, but is not limited to, a processor 2100, a memory/storage 2200, a communication interface 2300, and applications 2400. The device 2000 may include or implement, for example, the account networking device 1100, the mobile devices 1300, 1400, and 1500, the customer premise equipment 1110, the smart television 1120, the smartphone 1130, the laptop 1140, the IP video application server 1210, the fraud detection unit 1230, and the watch-time variability unit 1220, for example. In an implementation, the memory/storage 2200 may store the streaming, control, content, and like data gathered by the IP video application server 1210 and the watch-time variability generated by the watch-time variability unit 1220. The watch-time variability techniques or methods described herein may be stored in the memory/storage 2200 and executed by the processor 2100 in cooperation with the memory/storage 2200, the communications interface 2300, and applications 2400, as appropriate. The device 2000 may include other elements which may be desirable or necessary to implement the devices, systems, compositions and methods described herein. However, because such elements and steps are well known in the art, and because they do not facilitate a better understanding of the disclosed embodiments, a discussion of such elements and steps may not be provided herein.

Operationally, the IP video application server 1210 and/or the service provider system 1200 gathers data for the content viewed using a particular account. This data provides information on each piece of content viewed on the IP video application of the streaming devices. In implementations, the data is available at a stream level, a program level, or at both the stream and program level. Each stream is represented as a row containing, for example but not limited to, an account identifier, device identifier, start timestamp, duration, ip-address, and behind-the-modem flag as shown for example in Table 1.

TABLE 1

| FIELD NAME | DESCRIPTION |
|---|---|
| account_number | a unique identifier for the account consuming |
| | the stream |
| device_id | a unique identifier for a streaming device |
| start_timestamp | timestamp indicating when the stream began |
| watchtime_ms | number of milliseconds of content consumed |
| IP_address | list of IP address(es) that the streaming device |
| | had while stream was playing |
| behind_the_modem | boolean flag indicating whether the device was |
| | behind the account's networking device when the |
| | content was streamed |

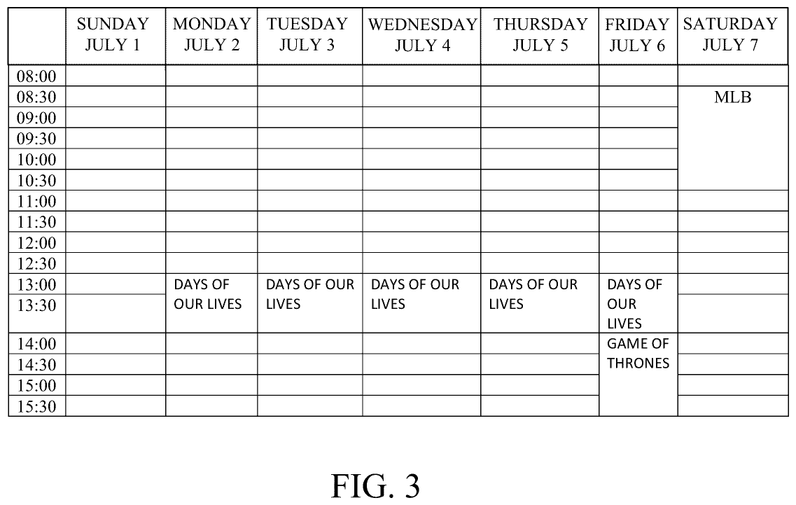

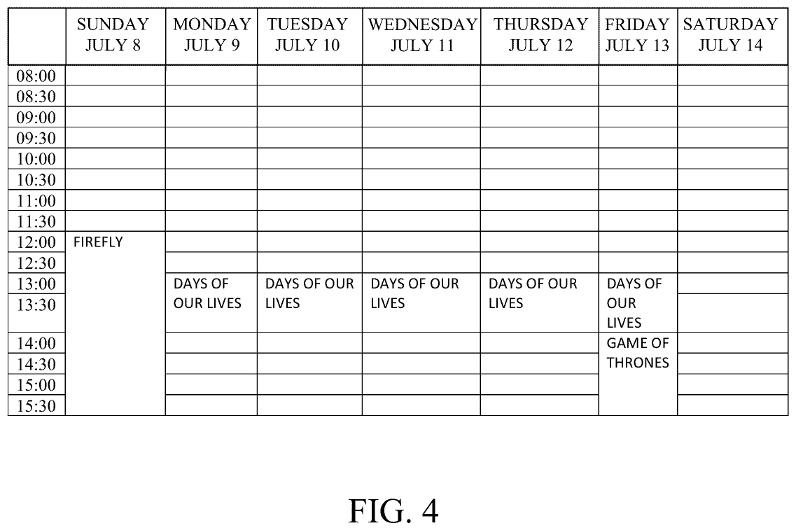

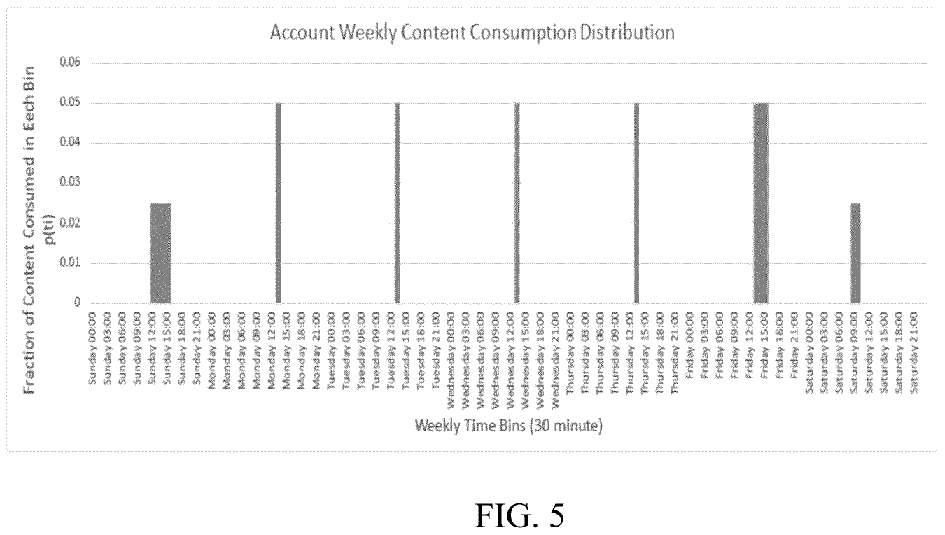

The watch-time variability unit 1220 processes the data to determine a watch-time variability. In implementations, the data is structured in terms of viewing habits, where a viewing habit is defined as time (when watched) and duration (how long watched) of content consumption over a recurring period. In implementations, the recurring period may be a week, a fortnight, a month, and the like. In an illustrative example, the recurring period is a week, as most viewing patterns vary between weekdays and weekends. A viewing pattern may be represented as a viewing distribution for the account. In implementations, the viewing distribution may be generated by dividing the week into time bins and then summing the total time spent consuming content during each time bin for a defined analysis period. In implementations, the time bin is thirty (30) minutes (in view of the convention of shows being 30 minutes or multiples thereof). The total time spent in each time bin is then normalized by dividing by the accounts total content consumption over the defined analysis period. This provides an estimate of the accounts viewing probability distribution which may be expressed as a function p(tᵢ), where p(tᵢ) is the fraction of an accounts consumption that occurs in a time bin tᵢ. FIGS. 3 and 4 are diagrams of content usage for a two-week period and FIG. 5 is a graph of content consumption distribution in accordance with implementations of this disclosure where the y axis represents the fraction of the content consumed and the x axis represents the time bins.

The watch-time variability unit 1220 then determines an account entropy [symbol] based on the account's viewing probability distribution p(tᵢ) as:

[symbol]

=−Σ_{∀i}p(tᵢ)log₂(p(tᵢ)) Equation (1)

The watch-time variability unit 1220 then uses the data as shown in Table 1 to effectively segment the streams into groups (that are likely to occur during credential sharing) and determine entropy values for each group. Grouping of the streams may be done using user profiles, show genres, streaming devices, IP addresses, and other attributes or characteristics which differentiates the streams in each of the resulting groups. In implementations, the number of groups is variable.

In implementations, stream segmentation may be reduced to segmenting the streaming devices into groups that are likely to be associated with credential sharing and those that are not. This is based on the observation that individuals from different households are unlikely to exchange streaming devices. Given this assumption, grouping of streaming devices may be implemented in a variety of ways. In implementations, streaming devices associated with the account in terms of using the account credential may be randomly assigned into two groups, such as a home group and a fraud group. In implementations, the assignment may be varied to maximize the information gain. This method, however, does not account for information about the nature of credential sharing. In particular, credential sharing may be defined as use of an account's credentials outside the household of the primary account holder, or by extension, necessarily outside the house of the primary account holder.

Given the above observations, in implementations, stream segmentation may be implemented by grouping of resources (i.e. the streaming devices and networks/IP addresses) that have a high probability of being localized (assigned, limited in use) to a single household. These groupings are identified using the data (such as the Table 1 data) to form a bipartite graph between devices and IP addresses. The nodes in the bipartite graph are IP addresses and streaming devices, and an edge is created whenever a stream occurs on a streaming device at a specific IP address. A cluster is defined as the disconnected components of the bipartite graph.

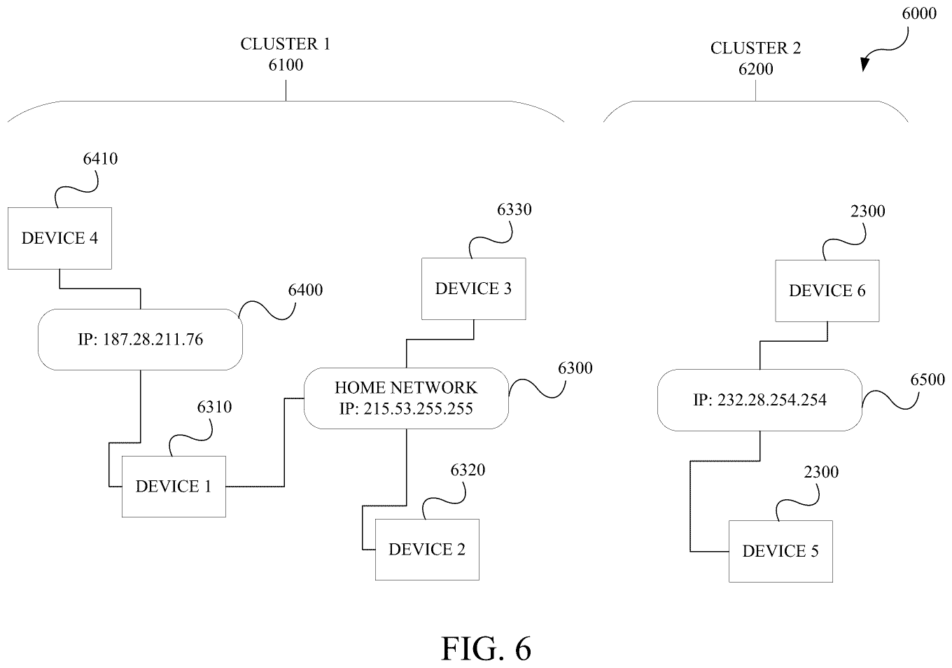

FIG. 6 is a bipartite graph 6000 showing cluster distribution in accordance with implementations of this disclosure. In an illustrative example, the bipartite graph 6000 is mapped to the architecture 1000 and components of FIG. 1. Using the components and stated relationships, the bipartite graph 6000 shows a cluster 1 6100 and a cluster 2 6200. The cluster 1 6100 includes a home network 6300 with an associated IP address and account password, where streaming device 1 6310, streaming device 2 6320, and streaming device 3 6330 have accessed the home network 6300 to stream content. The cluster 1 6100 further includes a second IP address 6400 due to the streaming device 1 6310 accessing the second IP address 6400 to stream content. Finally, the cluster 1 6100 includes streaming device 4 6410 which has accessed the second IP address 6400 to stream content. The cluster 2 6200 includes a third IP address 6500, where streaming device 5 6510 and streaming device 6 6520 have accessed the third IP address 6500 to stream content.

As evident from the bipartite graph 6000, the cluster 1 6100 includes streaming devices and IP addresses that are related or connected to the home network 6300, the associated IP address and the account password. The cluster 2 6200 streaming devices and IP addresses have no connection to the home network 6300, the associated IP address, the account password, or any other IP addresses or streaming devices which are connected to or associated with the home network 6300 and/or the associated IP address although the streaming device 5 6510 and streaming device 6 6520 have accessed the third IP address 6500 to stream content using the account password associated with the home network 6300. Activity this far removed from a home cluster may be considered very suspicious, and thus the streaming devices associated with the non-home cluster make excellent candidates for credential sharing.

Given the cluster determinations using the bipartite graph, cluster viewing probability distributions pⱼ(tᵢ) may be determined for each cluster, where pⱼ(tᵢ) is the fraction of cluster j's viewing in time bin tᵢ. For purposes of illustration, the streams occurring on streaming devices associated with a home cluster are denoted as home H and the streams occurring on streaming devices not associated with the home cluster are denoted as not-home NH. An entropy [symbol] _{H} and entropy [symbol] _{NH} are determined from each pⱼ(tᵢ) of each cluster. The watch-time variability, which is a measure of the information gain after stream segmentation, is then determined by:

watch−time variability= [symbol] −w_{H} [symbol] _{H}−w_{NH} [symbol] _{NH} Equation (2)

where the w_{H} and w_{NH} are weights determined by:

$${w}_{i} = \frac{{\sum }_{j ∈ {S}_{i}} watch - {time}_{j}}{{\sum }_{{j}^{′} ∈ S} watch - {time}_{{j}^{′}}} \qquad Equation ( 3 )$$

where i refers to either H or NH and Sᵢ is the set of streams that occurred on the home cluster or the non-home cluster, respectively. S is the set of all streams and watch−timeₖ is the watch-time for stream k. The weights the w_{H} and w_{NH} are essentially the fraction of the “total time spent consuming content” that occurred on a particular sub-group. As such, the sum of the weights, over all subgroups will equal 1. Although the example shows two groups, the number of groups is variable.

In an illustrative example, if the content being streamed is the same in both groups, then the watch-time variability is low or substantially near zero.

As an example, consider two groups that watch content at the exact same times each day of the week, say from 2:00pm to 2:30pm on Wednesday and 7:00am to 8:00am on Friday. As described above, the probability viewing distribution for group 1 would be:

$${p}_{1} ( {t}_{i} ) = \{ \begin{matrix}{p}_{1} ( {t}_{i} = 2 : 00 pm Wednesday ) & = \frac{1}{3} \\ {p}_{1} ( {t}_{i} = 7 : 00 am Friday ) & = \frac{1}{3} \\ {p}_{1} ( {t}_{i} = 7 : 30 am Friday ) & = \frac{1}{3} \\ {p}_{1} ( {t}_{i} = all other ) & = 0\end{matrix} \qquad Equation ( 4 )$$

Similarly, the probability view distribution for group 2 would be:

$${p}_{2} ( {t}_{i} ) = \{ \begin{matrix}{p}_{2} ( {t}_{i} = 2 : 00 pm Wednesday ) & = \frac{1}{3} \\ {p}_{2} ( {t}_{i} = 7 : 00 am Friday ) & = \frac{1}{3} \\ {p}_{2} ( {t}_{i} = 7 : 30 am Friday ) & = \frac{1}{3} \\ {p}_{2} ( {t}_{i} = all other ) & = 0\end{matrix} \qquad Equation ( 5 )$$

And the total probability viewing distribution for both groups would be:

$${p}_{T} ( {t}_{i} ) = \{ \begin{matrix}{p}_{T} ( {t}_{i} = 2 : 00 pm Wednesday ) & = \frac{1}{3} \\ {p}_{T} ( {t}_{i} = 7 : 00 am Friday ) & = \frac{1}{3} \\ {p}_{T} ( {t}_{i} = 7 : 30 am Friday ) & = \frac{1}{3} \\ {p}_{T} ( {t}_{i} = all other ) & = 0\end{matrix} \qquad Equation ( 6 )$$

Using these distributions in Equation 1, we get

[symbol]

= [symbol] ₁= [symbol] ₂=log₂(3) Equation (7)

Using equation 3 to calculate the weights, we see that group 1 and group 2 have the same weight, since they have both consumed the same amount of content.

$${w}_{2} = {w}_{1} = \frac{{\sum }_{j ∈ {S}_{1}} watch - {time}_{j}}{{\sum }_{{j}^{′} ∈ S} watch - {time}_{{j}^{′}}} = \frac{1.5 hours}{3 hours} = \frac{1}{2} \qquad Equation ( 8 )$$

Plugging Equations 7 & 8 into Equation 2, we get watch-time variability for two sub-clusters with identical watching patterns

$$watch - time variability = {ℋ}_{T} - {w}_{H} {ℋ}_{H} - {w}_{N H} {ℋ}_{N H} \qquad Equation ( 9 )$$

$$watch - time variability = {log}_{2} ( 3 ) - \frac{{log}_{2} ( 3 )}{2} - \frac{{log}_{2} ( 3 )}{2} = 0$$

In an illustrative example of indication of credential sharing, an account entropy is X, a home group entropy is Y, and a non-home group entropy is Z, where the Y and Z values are less than the X value as a result of stream segmentation. Consequently, the watch-time variability is a non-zero value, where the higher the value, the greater the indication of credential sharing.

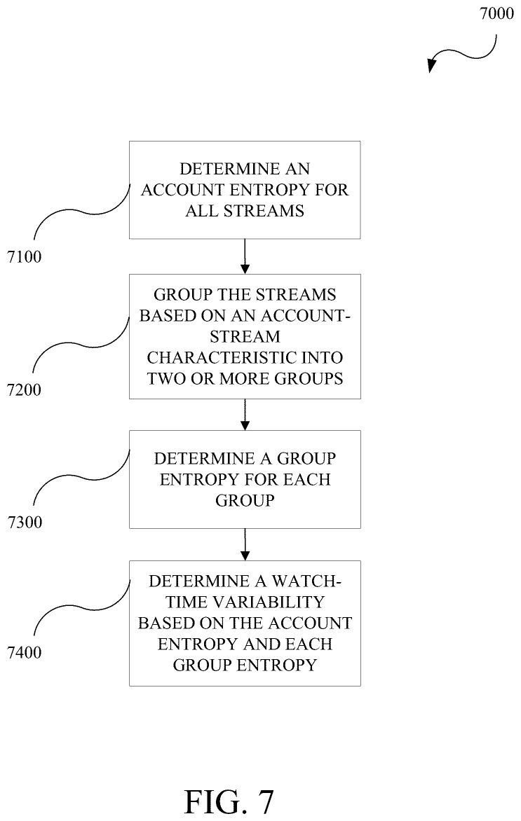

FIG. 7 is a flowchart of an example method 7000 for watch-time variability determination in accordance with embodiments of this disclosure. The method 7000 includes: determining 7100 an account entropy for all streams; grouping 7200 the streams based on an account-stream characteristic into two or more groups; determining 7300 a group entropy for each group; and determining 7400 a watch-time variability based on the account entropy and each group entropy. For example, the method 7000 may be implemented, as applicable and appropriate, by the system provider system 1200 of FIG. 1, the IP video application server 1210 of FIG. 1, the watch-variability unit 1220 of FIG. 1, the device 2000 of FIG. 2, and the processor 2100 of FIG. 2.

The method 7000 includes determining 7100 an account entropy for all streams. In implementations, the determining 7100 includes gathering account data for the content streamed using a particular account and account password. This data provides information on each piece of content streamed on IP video applications of accessing streaming devices. In implementations, the data is available at a stream level, a program level, or at both the stream and program level. In implementations, for each stream, the account data includes an account identifier, streaming device identifier, start timestamp, duration, IP address, a behind-the-modem flag, and like information which characterizes the stream, streaming device, and account (collectively account-stream characteristics). In implementations, the determining 7100 includes determining a probability of account viewing distribution. The account data is structured in terms of viewing patterns by defining a recurring period over which content is streamed and an analysis period which includes a defined number of recurring periods. Each recurring period is divided into time bins. From the account data, the amount of content streamed in each time bin is determined. The total time spent in each time bin is normalized by dividing a time bin total by the account's total content consumption over the analysis period to determine the probability of account viewing distribution. The account entropy is determined based on the probability of account viewing distribution.

The method 7000 includes grouping 7200 the streams based on an account-stream characteristic into two or more groups. For example, if genre was the account-stream characteristic then there may be a group for science fiction content and a group for horror content. In implementations, account-stream characteristics are used which segment the streams into groups that are likely to occur if credential sharing is present. In implementations, account-stream characteristics are used which group resources that have a high probability of being localized to a single household. In implementations, streaming devices and networks/IP addresses are used to segment the streams. For example, streaming devices that have been used at an account home location or are related to streaming devices that have been used at an account home location due to shared IP addresses may form one group and streaming devices that are not related may form other groups.

The method 7000 includes determining 7300 a group entropy for each group. For each determined group, a probability of account viewing distribution is determined from the account data, which is then used to determine the group entropy for each group.

The method 7000 includes determining 7400 a watch-time variability based on the account entropy and each group entropy. In implementations, the determining 7400 includes determining a weight for each group. In implementations, the weight is based on the watch-time for the streams in a particular group divided by the total amount of watch-time for all streams. In implementations, the watch-time variability is determined by subtracting each weighted group entropy from the account entropy. The watch-time variability may be used to determine account fraud which may lead to imposition of account restrictions or account termination.

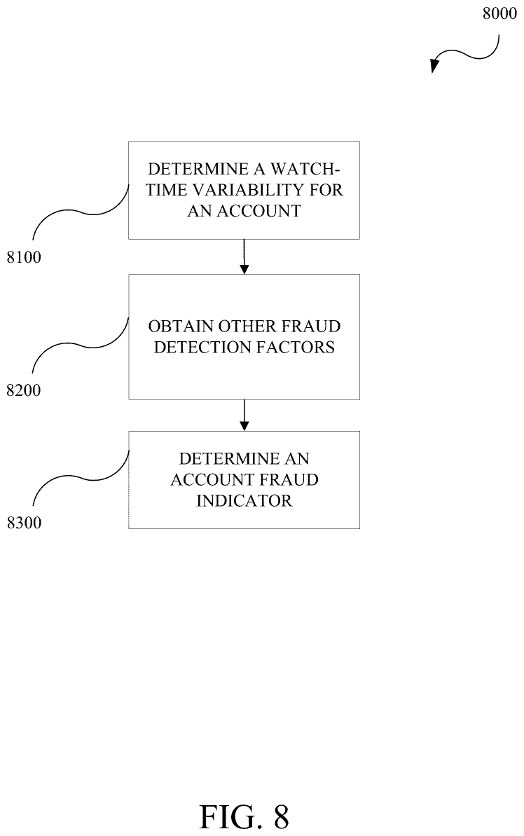

FIG. 8 is a flowchart of an example method 8000 for fraud determination in accordance with embodiments of this disclosure. The method 8000 includes: determining 8100 a watch-time variability for an account; obtaining 8200 other fraud detection factors; and determining 8300 an account fraud indicator. For example, the method 8000 may be implemented, as applicable and appropriate, by the system provider system 1200 of FIG. 1, the IP video application server 1210 of FIG. 1, the watch-variability unit 1220 of FIG. 1, the fraud detection unit 1230 of FIG. 1, the device 2000 of FIG. 2, and the processor 2100 of FIG. 2.

The method 8000 includes determining 8100 a watch-time variability for an account. In implementations, the watch-time variability may be determined as described in the specification, as described for example, with respect to FIG. 7.

The method 8000 includes obtaining 8200 other fraud detection factors. A number of other fraud factors may be used to determine account fraud. For example, the fraud factors can include out-of-home devices, non-home account network usage, non-home account location usage, out-of-home streaming volume, total concurrent streams, distant events relative to home account location, repeat device types, weighted concurrent streams, and the like.

The method 8000 includes determining 8300 an account fraud indicator. In implementations, each fraud factor including the watch-time variability may be assigned a weight based on reliability, accuracy, correctness, and the like. A probability of account fraud, i.e. the account fraud indicator, may then be based on the weighted fraud factors, which may lead to imposition of account restrictions or account termination.

In general, a method for determining watch-time variability includes obtaining, from a plurality of streaming devices, account and streaming data for all streams viewed on an account using an account password, generating, by a watch-time variability unit, a viewing probability distribution for the account, generating, by the watch-time variability unit, an account entropy based on the viewing probability distribution, grouping, by the watch-time variability unit, the streams into two or more groups, wherein the grouping uses an account-stream characteristic which has a probabilistic utility to indicate account password sharing, generating, by the watch-time variability unit, a group entropy for each of the two or more groups, determining, by the watch-time variability unit, a watch-time variability based on the account entropy and each group entropy, wherein the watch-time variability measures the increase in disorder when the two or more groups are unrelated with respect to the account-stream characteristic, and providing, by the watch-time variability unit, an indication of account password sharing to limit activity on the account. In implementations, the method includes determining, by the watch-time variability unit, a total amount of content streamed in a defined analysis period, determining, by the watch-time variability unit, an amount of content streamed in a defined time bin during a defined recurring interval for the defined analysis period, and normalizing, by the watch-time variability unit, the amount of content streamed in each defined time bin by the total amount of content streamed to generate the viewing probability distribution. In implementations, the account-stream characteristic uses streaming device identifiers and Internet Protocol (IP) addresses as a probabilistic indicator of single household localization. In implementations, the method includes identifying, by the watch-time variability unit, each streaming device which was used for streaming content using the account password from the account and streaming data, identifying, by the watch-time variability unit, each IP address which was used for streaming content using the account password from the account and streaming data, determining, by the watch-time variability unit, relationships between the identified streaming devices and identified IP addresses, identifying, by the watch-time variability unit, clusters which have disconnected streaming devices and IP addresses, and dividing, by the watch-time variability unit, the streams into the two or more groups based on the streams associated with the streaming devices in each cluster. In implementations, the method includes determining, by the watch-time variability unit, a weight for each group entropy, and subtracting, by the watch-time variability unit, each weighted group entropy from the account entropy to determine the watch-time variability. In implementations, the method includes determining, by the watch-time variability unit, the weight based on a watch-time for the streams in each group divided by the total amount of watch-time for all streams. In implementations, the method includes obtaining, by a fraud detection unit, fraud detection factors related to the account including the watch-time variability, and providing, by the fraud detection unit, an indication of account password sharing to limit activity on the account.

In general, a method for determining credential sharing includes determining a total amount of content streamed in a defined analysis period on an account with an account credential, wherein the defined analysis period includes repeatable periods, binning the total amount of content streamed into bins within the repeatable periods, generating a viewing probability distribution for the account based on normalized amount of content streamed per each bin, generating a total entropy for the account based on the viewing probability distribution, segmenting the content streamed into two or more groups, wherein segmentation uses characteristics of the content streamed which have a probabilistic utility in identifying credential sharing, generating a group entropy for each of the two or more groups, determining a watch-time variability based on the total entropy and each group entropy, wherein the watch-time variability measures the information gain when the two or more groups are disassociated as a result of segmentation using the characteristic, and indicating a presence of credential sharing to limit activity on the account based on the watch-time variability and other fraud factors. In implementations, normalizing the binned amount of content streamed by the total amount of content streamed to generate the viewing probability distribution. In implementations, the characteristic uses a combination of streaming device identifiers and Internet Protocol (IP) addresses as a probabilistic indicator of credential sharing. In implementations, the segmenting includes identifying each streaming device used to stream content on the account with the account credential during the defined analysis period, identifying each IP address used to stream content on the account with the account credential during the defined analysis period, determining associations between the identified streaming devices and identified IP addresses, detecting two or more clusters which have unassociated streaming devices and IP addresses, and grouping content streamed for each cluster. In implementations, the method includes determining a weight for each group entropy, and subtracting each weighted group entropy from the total entropy to determine the watch-time variability. In implementations, the method includes determining, by the watch-time variability unit, the weight based on a watch-time for the streams in each group divided by the total amount of watch-time for all streams. In implementations, the method includes obtaining other fraud detection factors related to the account, and weighting each fraud factor and the watch-time variability based on probabilistic utility in identifying credential sharing.

In general, a credential sharing detection system includes an Internet Protocol (IP) server configured to obtain from a plurality of streaming devices account and streaming data for streams viewed on an account using an account credential, and a processor in cooperation with the IP server. The processor configured to generate a viewing probability distribution for the account, generate an account entropy based on the viewing probability distribution, group the streams into two or more groups, wherein the grouping uses an account-stream characteristic which has a probabilistic utility to indicate account password sharing, generate a group entropy for each of the two or more groups, determine a watch-time variability based on the account entropy and each group entropy, wherein the watch-time variability measures the increase in disorder when the two or more groups are unrelated with respect to the account-stream, and provide an indication of account password sharing to limit activity on the account. In implementations, the processor further configured to determine a total amount of content streamed in a defined analysis period, determine an amount of content streamed in a defined time bin during a defined recurring interval for the defined analysis period, and normalize the amount of content streamed in each defined time bin by the total amount of content streamed to generate the viewing probability distribution. In implementations, the account-stream characteristic uses streaming device identifiers and Internet Protocol (IP) addresses as a probabilistic indicator of single household localization and the processor further configured to identify each streaming device which was used for streaming content using the account password from the account and streaming data, identify each IP address which was used for streaming content using the account password from the account and streaming data, determine relationships between the identified streaming devices and identified IP addresses, identify clusters which have disconnected streaming devices and IP addresses, and divide the streams into the two or more groups based on the streams associated with the streaming devices in each cluster. In implementations, the processor further configured to determine a weight based on a watch-time for the streams in each group divided by the total amount of watch-time for all streams, and subtract each weighted group entropy from the account entropy to determine the watch-time variability. In implementations, the processor further configured to obtain fraud detection factors related to the account including the watch-time variability, and provide an indication of account password sharing to limit activity on the account. In implementations, the processor further configured to weight each fraud factor and the watch-time variability based on probabilistic utility in identifying credential sharing.

Although some embodiments herein refer to methods, it will be appreciated by one skilled in the art that they may also be embodied as a system or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “processor,” “device,” or “system.” Furthermore, aspects of the present invention may take the form of a computer program product embodied in one or more the computer readable mediums having the computer readable program code embodied thereon. Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to CDs, DVDs, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

While the disclosure has been described in connection with certain embodiments, it is to be understood that the disclosure is not to be limited to the disclosed embodiments but, on the contrary, is intended to cover various modifications, combinations, and equivalent arrangements included within the scope of the appended claims, which scope is to be accorded the broadest interpretation so as to encompass all such modifications and equivalent structures as is permitted under the law.

What is claimed is:

1. A computer-implemented method for determining a credential sharing of a video streaming service account based on entropy of streaming data, the method comprising:
determining, by a watch-time variability unit, an account entropy based on a viewing probability distribution for a total amount of content streamed for a defined account within a defined analysis period, wherein the account entropy measures viewing behavior variability of the defined account over the defined analysis period;
grouping, by the watch-time variability unit, the total amount of content streamed into groups based on an account-stream characteristic that has probabilistic utility in determining the credential sharing;
determining, by the watch-time variability unit, a group entropy for each of the groups;
determining, by the watch-time variability unit, a watch-time variability based on the account entropy and each group entropy,
wherein the watch-time variability measures an increase in disorder when two or more groups of the groups are unrelated with respect to the account-stream characteristic for use in determining account password sharing, and
wherein determining the watch-time variability comprises:
determining, by the watch-time variability unit, a weight for each group entropy, wherein the weight is based on a watch-time for the streams in each group divided by a total amount of watch-time for the total amount of content streamed; and
subtracting, by the watch-time variability unit, each weighted group entropy from the account entropy in order to determine the watch-time variability; and
determining, by a fraud detection unit, the credential sharing for the defined account based on the watch-time variability.

2. The computer-implemented method of claim 1, further comprising:
binning, by the watch-time variability unit, the total amount of content streamed for the defined account within the defined analysis period into time bins, wherein each of the time bins corresponds to a defined time interval within the defined analysis period;
normalizing, by the watch-time variability unit, amount of content streamed in each time bin by the total amount of content streamed in order to generate the viewing probability distribution; and
generating, by the watch-time variability unit and based on normalized amount of content streamed, the viewing probability distribution for the defined account.

3. The computer-implemented method of claim 1, wherein the account-stream characteristic for use in determining account password sharing comprises a combination of streaming device identifiers and Internet Protocol (IP) addresses.

4. The computer-implemented method of claim 1, wherein the account-stream characteristic for use in determining account password sharing comprises a boolean flag that indicates whether a streaming device used to stream a portion of the total amount of content streamed is associated with a networking device associated with the defined account.

5. The computer-implemented method of claim 1, wherein determining the credential sharing for the defined account based on the watch-time variability comprises:
obtaining, by the fraud detection unit, one or more fraud detection factors including at least one of out-of-home device factor, non-home network usage factor, non-home account location usage factor, out-of-home streaming volume factor, total concurrent streams factor, distant events relative to home account location factor, repeat device types factor, or weighted concurrent streams factor;
determining, by the fraud detection unit, an account fraud indicator by assigning a weight to each of the one or more fraud detection factors and the watch-time variability, wherein the weight is assigned based on at least one of reliability, accuracy, and correctness; and
determining the credential sharing for the defined account based on the account fraud indicator.

6. The computer-implemented method of claim 5, further comprising:
responsive to determining the credential sharing for the defined account, imposing account restriction or account termination on the defined account.

7. The computer-implemented method of claim 1, further comprising:
providing, by the fraud detection unit, an indication of account password sharing to limit activity on the defined account.

8. The computer-implemented method of claim 1, further comprising:
identifying, by the watch-time variability unit, each streaming device used for streaming content of the total amount of content streamed using an account password from the defined account;
identifying, by the watch-time variability unit, each IP address used for streaming the content using the account password from the defined account;
determining, by the watch-time variability unit, relationships between identified streaming devices and identified IP addresses;
identifying, by the watch-time variability unit, clusters which have disconnected streaming devices and IP addresses; and
dividing, by the watch-time variability unit, the total amount of content streamed into the two or more groups based on streams associated with the streaming devices in each cluster.

9. A system comprising:
a watch-time variability unit configured to:
determine an account entropy based on a viewing probability distribution for a total amount of content streamed for a defined account within a defined analysis period, wherein the account entropy measures viewing behavior variability of the defined account over the defined analysis period;
segment, by the watch-time variability unit, the total amount of content streamed into groups based on an account-stream characteristic that has probabilistic utility in determining the credential sharing;
determine, by the watch-time variability unit, a group entropy for each of the groups;
determine, by the watch-time variability unit, a watch-time variability based on the account entropy and each group entropy, wherein
the watch-time variability measures the increase in disorder when two or more groups of the groups are unrelated with respect to the account-stream characteristic for use in determining account password sharing, and to determine the watch-time variability based on the account entropy and each group entropy comprises to:
determine a weight for each group entropy, wherein the weight is based on a watch-time for the streams in each group divided by a total amount of watch-time for the total amount of content streamed; and
subtract each weighted group entropy from the account entropy to determine the watch-time variability; and
a fraud detection unit configured to determine the credential sharing for the defined account based on the watch-time variability.

10. The system of claim 9, wherein the watch-time variability unit is further configured to:
bin the total amount of content streamed for the defined account within the defined analysis period into time bins, wherein each of the time bins corresponds to a defined time interval within the defined analysis period;
normalize an amount of content streamed in each time bin by the total amount of content streamed in order to generate a viewing probability distribution; and
generate, based on normalized amount of content streamed, the viewing probability distribution for the defined account.

11. The system of claim 9, wherein the account-stream characteristic for use in determining account password sharing comprises a combination of streaming device identifiers and Internet Protocol (IP) addresses.

12. The system of claim 9, wherein the account-stream characteristic for use in determining account password sharing comprises a boolean flag that indicates whether a streaming device used to stream a portion of the total amount of content streamed is associated with a networking device associated with the defined account.

13. The system of claim 9, wherein to determine the credential sharing for the defined account based on the watch-time variability comprises to:
obtain one or more fraud detection factors including at least one of out-of-home device factor, non-home network usage factor, non-home account location usage factor, out-of-home streaming volume factor, total concurrent streams factor, distant events relative to home account location factor, repeat device types factor, or weighted concurrent streams factor;
determine an account fraud indicator by assigning a weight to each of the one or more fraud detection factors and the watch-time variability, wherein the weight is assigned based on at least one of reliability, accuracy, and correctness; and
determine the credential sharing for the defined account based on the account fraud indicator.

14. The system of claim 10, wherein the fraud detection unit is further configured to:
responsive to determining the credential sharing for the defined account, impose account restriction or account termination on the defined account.

15. The system of claim 9, wherein the watch-time variability unit is further configured to:
identify each streaming device used for streaming content of the total amount of content streamed using an account password from the defined account;
identify each IP address used for streaming the content using the account password from the defined account;
determine relationships between identified streaming devices and identified IP addresses;
identify clusters which have disconnected streaming devices and IP addresses; and
divide the total amount of content streamed into the two or more groups based on streams associated with streaming devices in each cluster.

16. A credential sharing detection system comprising:
an Internet Protocol (IP) server configured to obtain from a plurality of streaming devices account data and streaming data for streams viewed on an account using an account credential, wherein a service provider associated with the IP server provides the account for streaming access via the account and the account credential;
a processor configured to cooperate with the IP server and connected to a tangible medium with instructions, the processor configured to execute the instructions to:
generate a viewing probability distribution for the account for use in determining an account credential sharing, wherein the viewing probability distribution is expressed as a function of a fraction of total amount of content streamed in a defined analysis period;
generate an account entropy based on the viewing probability distribution account for use in determining the account credential sharing;
group the streams into two or more groups based on an account-stream characteristic that has a probabilistic utility to indicate the account credential sharing, wherein to group the streams into the two or more groups comprises to:
determine relationships between streaming devices of the plurality of streaming devices used for streaming content using the account credential and IP addresses used for streaming the content;
compare among the relationships to determine respective one or more clusters that have disconnected streaming devices and respective IP addresses; and
divide the streams into the two or more groups based on the respective one or more clusters;
generate a group entropy for each of the two or more groups account for use in determining account credential sharing:
determine a watch-time variability based on the account entropy and each group entropy account for use in determining account credential sharing; and
provide, based on a respective value of the watch-time variability, an indication of account credential sharing to limit activity on the account.

17. The credential sharing detection system of claim 16, wherein to determine the watch-time variability comprises to:
determining a weight for each group entropy; and
subtract each weighted group entropy from the account entropy to determine the watch-time variability.

18. The credential sharing detection system of claim 16, wherein the processor is further configured to:
determine a total amount of content streamed in the defined analysis period;
determine an amount of content streamed in a defined time bin during a defined recurring interval for the defined analysis period; and
normalize the amount of content streamed in each defined time bin by the total amount of content streamed to generate the viewing probability distribution.

19. The credential sharing detection system of claim 16, wherein the processor is further configured to:
obtain one or more fraud detection factors including at least one of out-of-home device factor, non-home network usage factor, non-home account location usage factor, out-of-home streaming volume factor, total concurrent streams factor, distant events relative to home account location factor, repeat device types factor, or weighted concurrent streams factor;
determine an account fraud indicator by assigning a weight to each of the one or more fraud detection factors and the watch-time variability, wherein the weight is assigned based on at least one of reliability, accuracy, and correctness; and
detect credential sharing for the account based on the account fraud indicator.

20. The credential sharing detection system of claim 19, wherein the processor is further configured to:
responsive to determining the credential sharing for the account, impose account restriction or account termination.
